(19) United States
(12) Patent Application Publication
(10) Pub. No.: US 2026/0034402 A1
(43) Pub. Date: Feb. 5, 2026

(54) HYDRAULIC EXERCISE SYSTEM WITH BLOCKCHAIN-BASED TOKEN CONVERSION

(71) Applicant: Alan William Maynard, North Haven (AU)

(72) Inventor: Alan William Maynard, North Haven (AU)

(21) Appl. No.: 19/353,664

(22) Filed: Oct. 9, 2025

(51) Int. Cl. A63B 24/00; A63B 21/008; G06Q 20/36; G06Q 30/0208; G06Q 40/04

(52) U.S. Cl. CPC A63B 24/0059; A63B 21/008; G06Q 20/36; G06Q 30/0208; G06Q 40/049; A63B 24/0062; G06Q 2220/00

(57) ABSTRACT

A system and method for generating cryptocurrency coins based on physical exercise is provided. The system includes a hydraulic resistance control valve coupled to an actuator, which regulates bidirectional oil flow to establish a variable resistance load corresponding to the user's effort. An exercise attachment is mechanically coupled to the actuator, enabling a user to perform exercises. An electronic control unit equipped with pressure transducers and accelerometer sensors captures hydraulic pressure, resistance settings, and motion data, generating digital exercise data. A processor calculates power output in watts from the exercise data, converts the power output into exercise tokens according to a watt-to-token conversion algorithm, and transmits the tokens to a blockchain exchange interface. The blockchain exchange interface converts the tokens into cryptocurrency coins deposited into a user's cryptocurrency wallet. In some embodiments, the system further stores electrical energy in lithium-ion batteries and mints non-fungible tokens (NFTs) associated with performance milestones.

### FIELD OF THE INVENTION

The present disclosure relates to exercise systems and, more particularly, to systems and methods that measure user effort on hydraulic resistance devices, compute power output, and utilize the output for energy harvesting and cryptocurrency token generation.

### BACKGROUND

Exercise machines are widely used in strength training, athletic conditioning, and rehabilitation. Conventional systems often employ free weights, pneumatic cylinders, or basic hydraulic circuits to provide resistance against the user's applied effort. While these machines allow users to perform a variety of exercises, they present several limitations in terms of control, measurement, and reproducibility.

Traditional hydraulic exercise machines regulate resistance through manually adjustable dials that act on load control springs to vary fluid flow. Although this provides a variable load to the user, the adjustments are purely mechanical and lack precise feedback. As a result, users and therapists cannot easily determine the exact resistance setting being applied at any given time. This lack of verifiable information makes it difficult to reproduce exercise conditions consistently across sessions or between different machines.

Conventional hydraulic resistance systems also suffer from performance inconsistencies due to fluid dynamics. For example, changes in fluid viscosity caused by temperature increases during repeated use can alter resistance levels, even when the control dials remain unchanged. Entrained air within the hydraulic fluid can further destabilize system performance, leading to irregular resistance delivery. These factors compromise the reliability of resistance training and impede the accurate assessment of user performance.

In the field of rehabilitation, precision and repeatability are particularly critical. Therapists often need to limit the range of motion or apply carefully controlled resistance for patients recovering from injury or surgery. Existing machines rely heavily on manual adjustments to knobs, linkages, or clamps, without integrated means to verify or record the selected configurations. This creates difficulties in documenting treatment parameters, ensuring safety, and tracking patient progress over time.

Another limitation of existing systems is their inability to capture detailed exercise data. While some machines measure displacement or velocity, they do not combine these measurements with corresponding resistance information in a structured manner. Most isokinetic machines read in foot-pounds (ft/lbs) of torque and not in watts of power, which prevents accurate quantification of real-time work output. This results in incomplete or fragmented performance data, which restricts the ability to perform meaningful analytics, long-term power tracking, or comparative assessments across training sessions.

Furthermore, conventional exercise systems operate as stand-alone equipment and are not designed to integrate with modern digital ecosystems. The absence of connectivity and standardized data output prevents seamless use of exercise information in broader contexts such as performance analysis platforms, rehabilitation monitoring tools, or incentive-based engagement systems.

Accordingly, there is a need for a solution to the aforementioned problems. For example, there remains a need in the art for improved exercise systems that overcome these limitations by providing accurate, consistent, and verifiable control of resistance, stable operation across varying conditions, and enhanced capability for recording and tracking exercise performance.

### SUMMARY

The present disclosure provides a system for generating cryptocurrency coins based on physical exercise. The system integrates hydraulic resistance mechanisms, interchangeable exercise attachments, electronic sensing and processing units, blockchain-based conversion, and energy storage to measure physical effort, compute power output, and reward users with cryptocurrency tokens and coins.

In one embodiment, the system includes a hydraulic resistance control valve that regulates bidirectional oil flow between an actuator and a reservoir. The control valve generates variable resistance corresponding to user effort, and may comprise a pair of adjustable dials, load control springs, spools, and check valve arrangements. A fluid reservoir with a weir and baffle plate unit accommodates volumetric expansion and removes entrained air. The control valve may provide a dual unidirectional flow path, wherein one dial regulates resistance during actuator extension and another regulates resistance during actuator retraction.

An actuator is mechanically coupled to the control valve and to at least one exercise attachment. The exercise attachment may include lever arms, pedals, handles, platforms, or rotary members, and may be linked to the actuator through direct piston connections, pivot linkage mechanisms, rotary crank assemblies, or cable and pulley systems. Attachments may be removable and interchangeable, enabling different exercise types, such as leg, arm, trunk, or neck movements.

An electronic control (A to D converter) unit captures user effort and motion data, generating digital exercise data. The control unit includes a pressure transducer fluidly coupled to the control valve body to measure hydraulic pressure corresponding to user effort, and accelerometer sensors mounted on the control valve dials to detect resistance load settings and on exercise lever arms to detect displacement, velocity, or motion. The control unit aggregates pressure, resistance, and motion data for processing.

A processor communicatively coupled to the control unit calculates power output in watts based on pressure and motion data, and records resistance parameters as contextual information for validation. The processor converts wattage into exercise tokens using a watt-to-token conversion algorithm, transmits the tokens to a blockchain exchange interface, and initiates the conversion of the tokens into cryptocurrency coins. A cryptocurrency wallet associated with the user is configured to receive the coins securely. In some embodiments, the blockchain exchange interface includes a smart contract configured to validate the authenticity of the exercise tokens prior to conversion.

The processor may also mint non-fungible tokens (NFTs) or fan tokens associated with exercise milestones, leaderboard rankings, or high-output sessions. Such NFTs or fan tokens may represent digital performance badges or fan engagement assets, and may be transferable, tradable, or purchasable on blockchain-based marketplaces.

In another embodiment, the system includes an energy storage device configured to capture electrical energy generated from exercise and store it in lithium-ion batteries. The harvested energy may be tracked and tokenized as additional credits within the system, which classifies the system as a utility token.

The system may further provide an analytics dashboard configured to display real-time and historical performance metrics, including power output, tokens earned, NFTs obtained, and cumulative achievements. A global leaderboard may rank users based on accumulated wattage, exercise tokens, or NFTs, thereby enhancing engagement and motivation.

At least one component of the system, including the hydraulic resistance control valve, actuator, exercise attachment, electronic control unit (which includes an A to D converter), or processor, may include a machine-readable tag such as a QR code or NFC identifier. The tag may be scanned by a mobile application to initiate user authentication, bind exercise sessions to a registered user profile, and enable token transfer to the authenticated user's wallet upon session completion.

Collectively, the disclosed system enables the accurate measurement of exercise effort, the fair and verifiable conversion of physical activity into digital value, the storage of generated electrical energy, the issuance of tradable tokens and NFTs, and integration with blockchain networks for secure transactions and reward distribution.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 shows a block diagram of an exercise-to-cryptocurrency system in accordance with some embodiments of the present disclosure;

FIG. 2 shows an example isokinetic exercise device, but not limited to one device, in accordance with some embodiments of the present disclosure;

FIGS. 3A and 3B show different perspectives on the isokinetic assembly of the isokinetic exercise device in accordance with some embodiments of the present disclosure;

FIG. 4 illustrates a detailed sectional view of a hydraulic resistance control valve in accordance with some embodiments of the present disclosure;

FIG. 5 shows a detailed block diagram illustrating the server in accordance with some embodiments of the present disclosure;

FIG. 6 illustrates a flow diagram of an example method for capturing exercise records in accordance with some embodiments of the present disclosure;

FIG. 7 illustrates a flow diagram of an example method for converting exercise activity into cryptocurrency reward tokens, in accordance with some embodiments of the present disclosure;

FIG. 8 shows a user performing shoulder abduction, in accordance with some embodiments of the present disclosure;

FIG. 9 illustrates a user performing a shoulder internal rotation exercise, in accordance with some embodiments of the present disclosure;

FIG. 10 illustrates a user performing a wrist strengthening exercise, in accordance with some embodiments of the present disclosure;

FIG. 11 illustrates a user performing ankle flexion and extension movements, in accordance with some embodiments of the present disclosure;

FIG. 12 illustrates a user performing elbow flexion and extension exercise, in accordance with some embodiments of the present disclosure;

FIG. 13 illustrates a user performing hip flexion, extension, abduction, and adduction exercises, in accordance with some embodiments of the present disclosure;

FIG. 14 illustrates a user performing a trunk exercise, in accordance with some embodiments of the present disclosure;

FIG. 15A illustrates a user performing a cervical flexion and extension exercise in accordance with some embodiments of the present disclosure;

FIG. 15B illustrates a user performing a lateral side-to-side head exercise in accordance with some embodiments of the present disclosure; and

FIG. 16 illustrates a user performing a cervical rotational exercise in accordance with some embodiments of the present disclosure.

Like reference numerals refer to like parts throughout the several views of the drawings.

### DETAILED DESCRIPTION

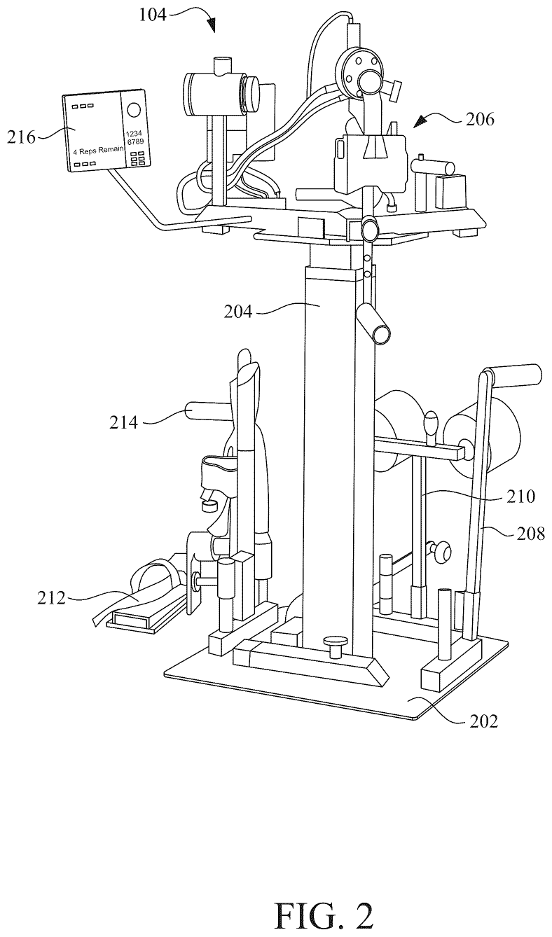

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 2. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

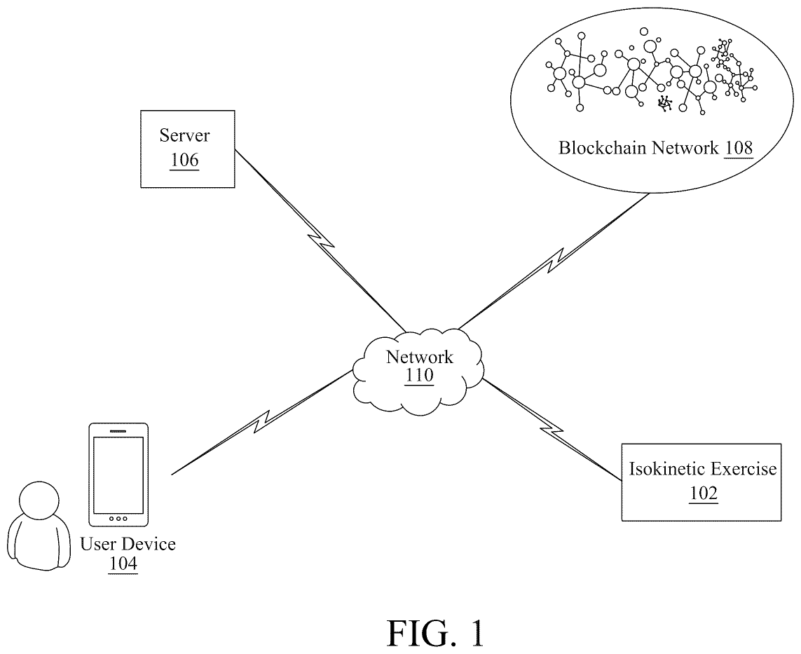

Referring initially to FIG. 1, which shows an example exercise-to-cryptocurrency system 100 in accordance with some embodiments of the present disclosure. As illustrated in FIG. 1, the system 100 comprises an isokinetic exercise device 102, a user device 104, a server 106, and a blockchain network 108. The isokinetic device 102, the user device 104, the server 106, and the blockchain network 108 are communicatively coupled via a network 110.

The system 100 comprises the isokinetic exercise device 102, which is a fitness or rehabilitation device equipped with hydraulic resistance control, actuators, sensors, and conversion units. The isokinetic device 102 is configured to measure user effort, capture mechanical data such as force and velocity, and convert such data into digital exercise data. As discussed in detail in relation to FIG. 2, the isokinetic exercise device 102 includes hardware and embedded electronics that allow exercise performance to be quantified in terms of power output, which can then be converted into exercise tokens or other digital assets.

Further, the exercise-to-cryptocurrency system 100 comprises the user device 104. The user device 104 comprises an integrated platform that serves as a gateway for the user to engage with the isokinetic exercise device 102 and the server 106. In some embodiments, a user associated with the user device 104 may initiate an exercise session by scanning a machine-readable tag (e.g., QR code or NFC identifier) located on the isokinetic exercise device 102. The user device 104 may also be configured to receive biometric authentication or login credentials to verify the user's identity before the exercise session begins. During the exercise, the user device 104 may display real-time feedback such as power output, resistance setting, workout duration, or token accumulation. Upon completion of the session, the user device 104 enables the user to view and manage information related to their workout, including the total power output in watts, the number of exercise tokens generated, cryptocurrency coins transferred to the user's wallet, and any non-fungible tokens (NFTs) or fan tokens minted from the exercise session. In some embodiments, the user device 104 may further provide notifications when exercise tokens are converted to cryptocurrency coins, when leaderboard rankings are updated, or when a fan engages in a marketplace transaction involving the user's NFT or fan token.

In some embodiments, the integrated platform of the user device 104 may be a dedicated mobile application installed on the user device 104, a web application accessed through a browser associated with the user device 104, or Original Equipment Manufacturer (OEM) software integrated into the device operating system. The user device 104 may be implemented as any electronic device capable of communication with the network 110, such as a desktop computer, laptop computer, portable or mobile device, smartphone, tablet computer, personal digital assistant (PDA), wearable device, or a fitness-specific connected device. The user device 104 may further be configured to synchronize with third-party applications or platforms to share workout achievements, display global leaderboard standings, or enable social engagement features.

In some embodiments, the user device 104 may further be implemented as a display or kiosk located proximate to the isokinetic exercise device 102, through which the user can access session information, authentication, and performance data. In some other embodiments, the user device 104 may be directly connectable to the isokinetic exercise device 102 through a cable, such as HDMI, VGA, USB, or any other suitable wired connection, thereby enabling the user device 104 to display exercise performance metrics in real-time. The user device 104 may further be configured to synchronize with third-party applications or platforms to share workout achievements, display global leaderboard standings, or enable social engagement features.

The system 100 also comprises the server 106, which is configured to process digital exercise data received from the isokinetic exercise device 102, perform watt-to-token conversion, and coordinate blockchain transactions. In some embodiments, the server 106 maintains a local or cloud-based database storing user profiles, session history, token balances, and analytics dashboards. In some other embodiments, the server 106 may also implement smart contract triggers and act as a blockchain oracle to verify session validity before releasing the token.

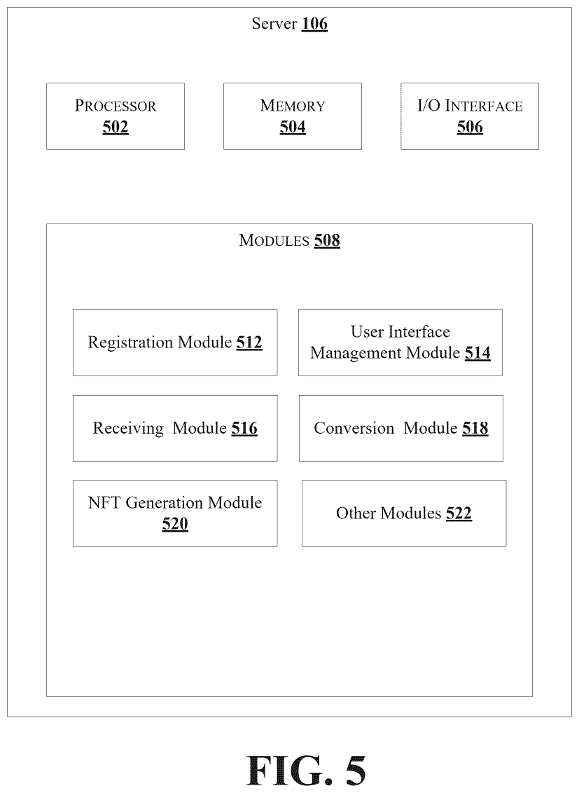

In some embodiments, the server 106 acts as a processing and orchestration component. The server 106 receives the digital exercise data from the isokinetic exercise device 102 and computes power output in watts based on the exercise data. The server 106 then executes a watt-to-token conversion algorithm, which may apply linear or tiered exchange rates, multipliers, or scaling factors that depend on resistance level, workout duration, or gamification parameters. The server further validates session data, initiates blockchain smart contract triggers, and ensures tokens are only released for authenticated and verified sessions. As discussed in detail in relation to FIG. 5, the server 106 comprises several key components that work in harmony to register the users and isokinetic exercise devices, receive the exercise data from the isokinetic exercise device when the user perform an exercise with the isokinetic exercise device, compute a power output in watts based on the received exercise data, convert the power output into exercise tokens, and enable the conversion of the exercise tokens into cryptocurrency coins and load them in a crypto wallet associated with the user.

The system 100 further comprises the blockchain network 108, which operates as a distributed ledger. Once exercise data is validated by the server 106, the corresponding exercise tokens or cryptocurrency coins are recorded in the blockchain network 108. The blockchain network 108 ensures immutability, transparency, and verifiability of exercise-to-token conversions. Each transaction stored in the blockchain network 108 may be time-stamped and cryptographically secured. In some examples, the blockchain network 108 may be implemented on a public blockchain such as Ethereum, Solana, or another compatible decentralized ledger technology. In some embodiments, the blockchain network 108 also supports issuance of non-fungible tokens (NFTs) representing performance milestones, leaderboard achievements, or fan tokens. These assets are cryptographically secured, time-stamped, and immutable, enabling transparent proof of performance.

The system 100 further supports analytics and fan monetization. Exercise data transmitted from the isokinetic exercise device 102 and processed by the server 106 is presented on global leaderboards and dashboards accessible via the user device 104. High-output sessions may trigger the minting of NFTs, which may be displayed in the athlete's profile and made tradable in blockchain-based fan marketplaces. Fans can purchase, transfer, or trade these tokens, thereby creating a secondary engagement economy that is layered on top of the exercise-to-cryptocurrency conversion. The athlete's cryptocurrency wallet associated with the blockchain network 108 securely stores both coins and NFTs for later use.

The network 110 provides connectivity among the isokinetic exercise device 102, the user device 104, the server 106, and the blockchain network 108. The network 110 may be implemented using one or more of the Internet, a local area network (LAN), a wide area network (WAN), a wireless network, or a cellular network. In some embodiments, secure protocols such as HTTPS, TLS, or blockchain-specific APIs are used for communication.

It is worth noting that, although FIG. 1 shows a single isokinetic exercise device 102, a single user device 104, a single server 106, and a single blockchain network 108, a person skilled in the art would appreciate that the system 100 may comprise a plurality of such devices, which are not shown herein for the sake of brevity.

Referring now to FIG. 2, which illustrates an example isokinetic exercise device 102 in accordance with some embodiments of the present disclosure.

The isokinetic exercise device 102 includes a base 202. The base 202 comprises a substantially rigid structure having a bottom surface configured to rest flat on a floor or other support surface. The base 202 provides structural stability for the exercise system and is dimensioned to withstand the combined weight of the machine components mounted thereon and the forces applied by a user during exercise. In some embodiments, the base 202 may be generally rectangular, although other geometries, such as square, oval, polygonal, or custom-shaped bases, may be employed. The base 202 may be fabricated from a metallic material, such as steel or aluminum, or a composite material with sufficient load-bearing capacity. The base 202 may include mounting holes or brackets configured to secure the isokinetic exercise device 102 to a fixed surface, thereby improving stability during high-load training.

In some embodiments, the base 202 may further include one or more wheels or casters mounted on its underside to enable the entire isokinetic exercise device 102 to be moved easily from one location to another. The wheels may be lockable to prevent unintended movement during exercise, thereby maintaining stability when the isokinetic exercise device 102 is in use. In other embodiments, the wheels may be retractable or integrated with a stabilizing frame to balance portability with structural rigidity.

The base 202 further supports a vertical member 204 extending upwardly therefrom. The vertical member 204 may be fixedly attached or removably mounted onto the base 202 using suitable fasteners such as bolts, screws, or brackets. In some embodiments, the base 202 and vertical member 204 may be manufactured as a unitary structure. The vertical member 204 is configured to support the principal operating components of the isokinetic exercise device 102, including resistance elements, actuators, sensors, and exercise attachments. In the illustrated embodiment, the vertical member 204 has a substantially rectangular cross-section, although other shapes, such as cylindrical, polygonal, or reinforced tubular profiles, may be employed depending on load and stability requirements. The vertical member 204 may also be hollow, allowing hydraulic lines, electrical cables, and signal conduits to be routed internally.

In some embodiments, the vertical member 204 may further include or be coupled to a horizontal member (not shown in FIG. 2) that is configured to receive and support the isokinetic assembly 206. The horizontal member may extend outwardly from the vertical member 204 in a substantially perpendicular orientation relative to the vertical member 204, thereby providing a stable platform for mounting the isokinetic assembly 206. In certain implementations, the horizontal member may be integrally formed with the vertical member 204 or may be removably attached using fasteners, brackets, or other coupling mechanisms. The horizontal member allows for secure positioning of the isokinetic assembly 206 and may also facilitate height adjustment or modular replacement of the assembly.

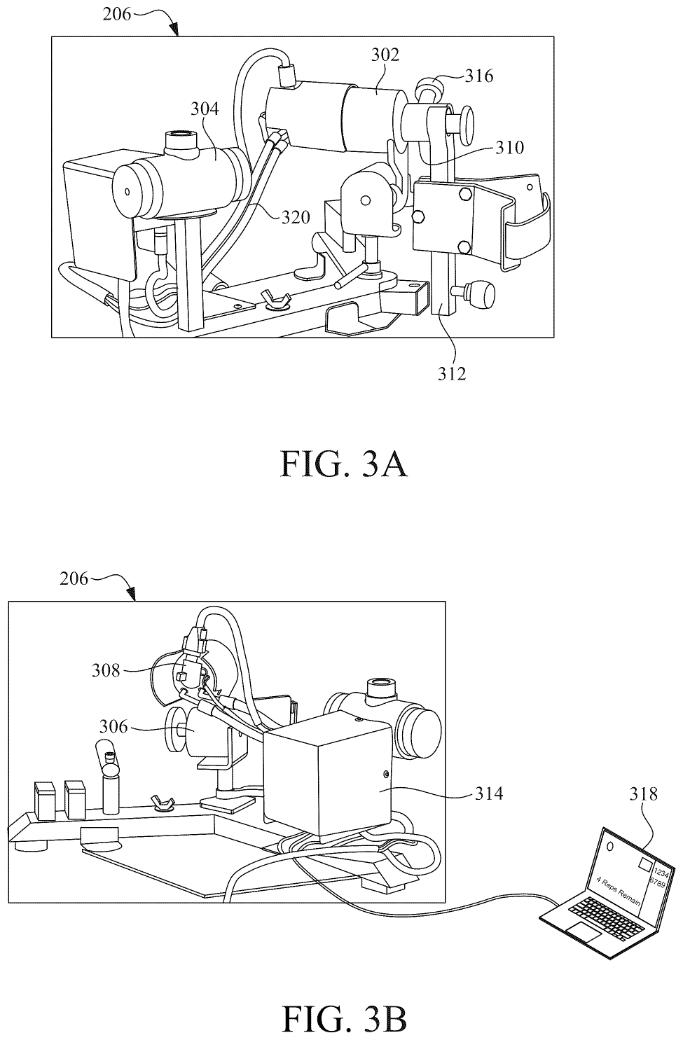

The isokinetic exercise device 102 further includes the isokinetic assembly 206, which is mounted on and supported by the vertical member 204. The isokinetic assembly 206 comprises the principal functional elements of the exercise system that collectively generate resistance, capture exercise performance data, and provide mechanical coupling to interchangeable exercise attachments. In some embodiments, the isokinetic assembly 206 may comprise, without limitation, a hydraulic resistance control valve, one or more actuators, a sensor and conversion unit, and one or more exercise attachments, as described in greater detail below. The isokinetic assembly 206 is explained in further detail with respect to FIGS. 3A and 3B that illustrate exemplary internal arrangements and operational flow paths of the assembly.

Further, as illustrated in FIG. 2, one or more exercise attachments 208-214 are placed on or proximate to the base 202. These exercise attachments 208-214 may be selectively coupled to the isokinetic assembly 206 based on the type of exercise the user desires to perform. For example, a lever arm attachment may be used for upper-body pushing or pulling exercises, a pedal assembly may be used for cycling or rotary motion, and a platform may be used for leg press or squat exercises. The storage of one or more exercise attachments 208-214 on the base 202 provides convenient accessibility, reduces the need for external storage equipment, and enables quick interchangeability of attachments during or between exercise sessions. In some embodiments, the base 202 may include dedicated mounting brackets, holders, or recesses configured to securely retain one or more exercise attachments 208-214 when not in use.

Furthermore, as illustrated in FIG. 2, the display unit 216 may be connected to the isokinetic assembly 206. The display unit 216 may be configured to display a visual representation of the user's performance when a user performs an exercise using the isokinetic exercise device 106.

Referring now to FIGS. 3A and 3B illustrate different perspectives on the isokinetic assembly 206 of the isokinetic exercise device 102. FIGS. 3A and 3B collectively illustrate the principal components of the isokinetic assembly 206, which generate resistance, capture exercise data, and provide mechanical coupling to exercise attachments.

The isokinetic assembly 206 includes an actuator 302, which may be implemented as a hydraulic cylinder, a piston-based actuator, or a rotary actuator. The actuator 302 is operably coupled to a hydraulic resistance control valve 304. For example, the actuator 302 is fluidly connected to the hydraulic resistance control valve 304 via a pair of hydraulic hoses 320.

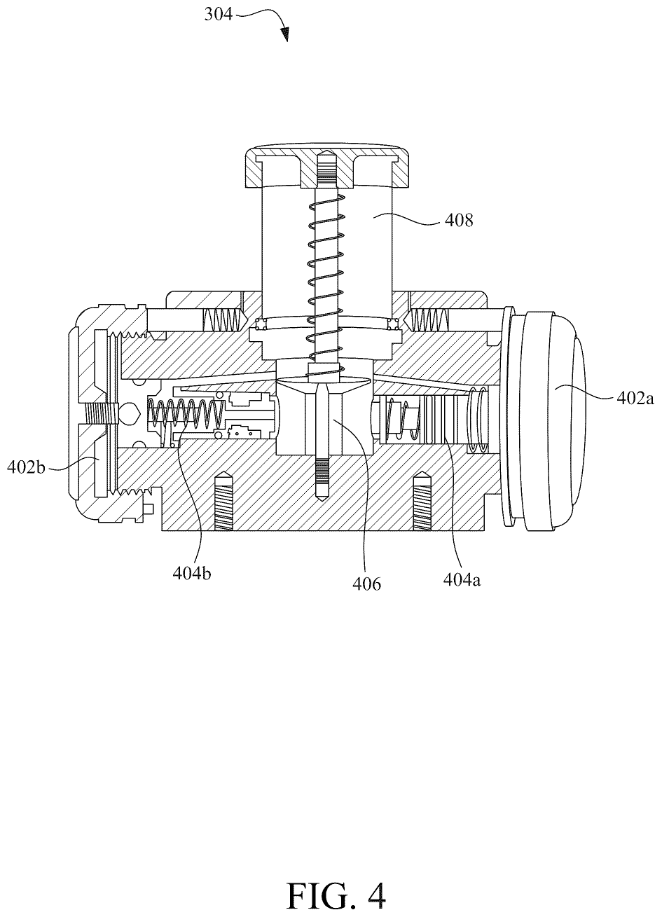

The hydraulic resistance control valve 304 regulates bidirectional fluid flow between the actuator 302 and an associated reservoir, thereby generating variable resistance loads in response to user-applied effort. As discussed in detail in relation to FIG. 4, the hydraulic resistance control valve 304 includes dual flow paths configured to provide independent resistance during actuator extension and retraction.

Also shown in FIGS. 3A and 3B are adjusting knobs 306, illustrated as red mechanical knobs positioned at pivot or hinge points where the actuator 302 and its connected hydraulic cylinder interface with the frame. The adjusting knobs 306 are mechanical adjustment and locking components configured to set and secure the physical configuration of the assembly. By loosening the adjusting knob 306, the actuator 302, a torque arm 310, and a connected platform can be repositioned to a different angle relative to the user's joint or the base 202. In some embodiments, the adjusting knobs 306 operate in conjunction with a clutch device or an electronic linear actuator to enable vertical adjustment of the exercise platform. Once the desired position is achieved, tightening the adjusting knobs 306 locks the isokinetic assembly 206 in place.

The primary function of the adjusting knobs 306 is to control alignment and range of motion rather than resistance. For example, a therapist may restrict an ankle platform to a small angular range during early rehabilitation and later increase the allowed motion as the patient progresses. Similarly, for neck rehabilitation exercises, the adjusting knobs 306 may be used to limit or extend the degree of cervical rotation, ensuring that the actuator 302 remains biomechanically aligned with the natural motion of the joint. The adjusting knobs 306 therefore act as positioning and range-limit controls, ensuring both safety and personalization of exercise therapy.

Mounted near the actuator 302 is an accelerometer device 308. The accelerometer 308 is configured to detect displacement, angular velocity, or acceleration of the actuator 302 or its associated attachments. The accelerometer 308 generates motion data representative of the user's exercise performance, which is relayed to the electronics control unit 314 for further processing. The accelerometer may be a MEMS-based sensor integrated on a printed circuit board and positioned in a protective housing.

Extending outwardly from the actuator 302 is the torque arm 310, which serves as the mechanical interface between the actuator and the user. A user couples a selected exercise attachment 312 to the torque arm 310. The exercise attachment 312 is secured and positioned using a spring-loaded locking knob 316, which allows for rapid interchangeability between different exercise attachments, such as lever arms, pedals, handles, or platforms. This design allows the exercise system 200 to be configured for a wide variety of training and rehabilitation movements.

The isokinetic assembly 206 further comprises an electronics control unit 314, which houses signal processing, control circuitry, and communication interfaces. The electronics control unit 314 may include one or more microcontrollers, processors, and memory devices for executing embedded logic. The embedded logic may be configured to receive and process signals from the accelerometer 308, other accelerometers located near the hydraulic resistance control valve 304, and any pressure sensors fluidly coupled to the hydraulic resistance control valve 304. The electronics control unit 314 may further condition the signals, convert them into digital form through an analog-to-digital (A/D) module, and transmit processed exercise data to the server 106 or user device 104 via wired or wireless communication.

The processed exercise data may include hydraulic pressure readings, displacement values, angular velocity, torque, and calculated power output. These parameters are subsequently used by the system for watt-to-token conversion, blockchain integration, and analytics generation as described with respect to FIG. 1. In some embodiments, the electronics control unit 314 is implemented as a modular component that can be upgraded or replaced independently of the actuator 302 and hydraulic resistance control valve 304, thereby enabling long-term adaptability of the system.

Further, as shown in FIG. 3B, an electronic device 318, such as a laptop computer, tablet, or other suitable display terminal, may be connected to the electronics control unit 314 of the isokinetic assembly 206. The electronics control unit 314 may be configured to capture, process, and transmit exercise data obtained from the actuator 302, the hydraulic resistance control valve 304, the accelerometer device 308, and any associated pressure transducers. The electronic device 318 may display a visual representation of the user's performance during exercise, including parameters such as displacement, velocity, torque, range of motion, power output, and accumulated training volume. In some embodiments, the electronic device 318 may be a dedicated display, as shown in FIG. 2, provided by the manufacturer of the isokinetic exercise device 102, serving as the display unit 216. In other embodiments, the electronic device 318 may correspond to the previously described user device 104, operated by the user.

In some embodiments, the connection between the electronics control unit 314 and the electronic device 318 may be established through a wired interface, such as USB, HDMI, or other compatible data cables. In other embodiments, the connection may be wireless, utilizing Bluetooth, Wi-Fi, or other short-range or long-range communication protocols. The visual interface presented on the electronic device 318 may include real-time graphs, numerical indicators, progress dashboards, or rehabilitation targets, thereby allowing both users and therapists to monitor exercise sessions directly as they occur.

FIG. 4 illustrates a detailed sectional view of a hydraulic resistance control valve 304 in accordance with some embodiments of the present disclosure. The control valve 304 is implemented as a dual unidirectional control valve, enabling independent regulation of hydraulic flow in both directions of actuator 302 movement. The actuator 302 is fluidly connected to the control valve 304 via a pair of hydraulic hoses, each of which is coupled to an internal check valve (not shown) within the valve body. When the actuator 302 is displaced, the resulting hydraulic pressure is routed through the appropriate flow path depending on the direction of motion, thereby generating controlled resistance for both extension and retraction phases.

The control valve 304 includes a pair of control knobs or dials 402a and 402b, each operatively coupled to a corresponding load control spring 404a and 404b. Rotation of the dials 402a and 402b adjusts the preload on their respective springs, thereby determining the threshold hydraulic pressure required to displace the control spool 406. When sufficient pressure is generated by actuator 302, the control spool 406 moves against the spring preload, opening a port and actuating a check valve. This allows hydraulic fluid to flow from the pressurized side of the actuator, through the opened check valve, and back into the return line toward the opposite side of the actuator. Reverse operation during actuator retraction occurs in a similar manner, utilizing the opposing spring and spool configuration.

To enhance functionality, each control dial 402a, 402b may be fitted with an accelerometer cell configured to detect and record the angular position of the dial. These accelerometer cells communicate with the electronics control unit 314, thereby reporting the selected resistance settings in real-time (e.g., “3 up” and “5 down” load selections). This ensures that the digital exercise data generated by the system not only reflects measured pressure and motion values, but also the exact dial settings applied during exercise.

The control valve 304 further incorporates a fluid reservoir 408 configured to accommodate volumetric expansion of hydraulic fluid due to temperature rise during prolonged usage. The reservoir 408 includes a weir and baffle plate unit that automatically separates and removes entrained air during initial filling and subsequent operation. This prevents cavitation, reduces pressure fluctuations, and ensures smoother resistance delivery to the user.

A pressure transducer fluidly coupled to the valve body may monitor the system pressure generated within the control valve 304. The system calculates torque, power output, and cumulative energy expenditure with displacement and velocity data from accelerometers mounted on the actuator 302 and/or one or more exercise attachments. These parameters may be displayed in real time on the user device 104, recorded in session logs, or transmitted for further processing, including watt-to-token conversion and blockchain integration.

FIG. 5 shows a detailed block diagram illustrating the server 106 in accordance with some embodiments of the present disclosure.

The server 106 is a critical component within the exercise-to-cryptocurrency system 100, responsible for managing exercise data, performing token conversion, and interacting with the blockchain network 108. In an implementation, the server 106 may comprise a processor 502, a memory 504, an I/O interface 506, and one or more modules 508.

The processor 502 may be configured to perform one or more functions to fulfill requirements of the server 106, including computation of power output, token conversion, smart contract execution, and NFT generation. The memory 504 may be communicatively coupled to the processor 502 and may store user profiles, workout histories, token balances, and blockchain transaction records. The I/O interface 506 may be configured to enable the server 106 to communicate with the user device 104, the isokinetic exercise device 102, and the blockchain network 108 via the network 110.

In some implementations, the server 106 may comprise the one or more modules 508 for performing various operations in accordance with some embodiments of the present disclosure. In some embodiments, the one or more modules 508 may be stored as part of the processor 502. In other embodiments, the one or more modules 508 may be communicatively coupled to the processor 502 to perform one or more functions of the server 106. The one or more modules 508 may comprise, without limiting to, a registration module 512, a user interface management module 514, a receiving module 516, a conversion module 518, an NFT generation module 520, and other modules 522.

As used herein, the term module refers to an application-specific integrated circuit (ASIC), an electronic circuit, a processor (shared, dedicated, or group), and memory that executes one or more software or firmware programs, a combinational logic circuit, and/or other suitable components that provide the described functionality. In an embodiment, the other modules 522 may be used to perform various miscellaneous functionalities of the server 106. It would be appreciated if such other modules 522, could be represented as a single module or a combination of different modules.

In some examples, the processor 502 may comprise at least one controller in communication with at least one non-transitory processor-readable medium. The processor-readable medium may have instructions stored thereon which, when executed, cause the processors to perform or control performance of the operations as described herein. Furthermore, in some examples, the processor 502 or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by one or more controllers (e.g., microcontrollers), as one or more programs executed by one or more processors (e.g., microprocessors, central processing units, graphical processing units), as firmware, and the like, or as a combination thereof.

The one or more modules 508 comprises the registration module 512. The registration module 512 is configured to handle initialization, enrollment, and association of users, devices, and wallets in the system. In some embodiments, the registration module 512 registers a user by creating a secure user profile that includes identifiers such as username, biometric information, cryptographic keys, or authentication tokens. The registration module 512 may further register the user device 104 (e.g., smartphone, tablet, kiosk display) by linking the device to the user profile via a secure handshake protocol. Additionally, the registration module 512 may register the isokinetic devices 102 itself, generating unique device identifiers (e.g., UUID, hardware fingerprint, NFC tag ID, or QR code) that bind future exercise sessions to the authenticated hardware. This ensures that workouts are verifiably associated with legitimate devices and prevents fraudulent injection of exercise data. In some embodiments, the registration module 512 may also provision a cryptocurrency wallet for each user, either by generating a private/public key pair and storing it locally on the user device 104 or by integrating with external custodial wallet providers. The association between the user, wallet, and registered isokinetic device 102 establishes a trusted environment for secure data capture and token disbursement.

The one or more modules 508 further comprises the user interface management module 514, which is configured to generate, update, and render graphical and textual representations of exercise data, token rewards, and achievements. The user interface management module 514 may create dashboards that display key performance indicators such as instantaneous wattage, cumulative energy generated, number of repetitions, average speed, calories expended, and resistance levels applied. The user interface management module 514 may also provide leaderboards that rank users based on session performance, long-term statistics, or token earnings, enabling competitive or community engagement. In some embodiments, the user interface management module 514 provides gamified visual feedback, such as progress bars, milestone badges, or virtual environments that respond dynamically to the user's effort. For example, as the user generates more watts, an on-screen avatar may progress through a virtual racecourse. The user interface management module 514 is further configured to provide real-time session feedback, including warnings for improper biomechanics (detected via motion sensors) or fatigue alerts. In some embodiments, the user interface management module 514 may integrate with wearable devices (e.g., smartwatches, HR monitors) to overlay heart rate, oxygen saturation, or recovery data on the performance dashboard. Data displayed by the user interface management module 514 may be accessed on the user device 104, on an integrated manufacturer-provided display, or on third-party systems through an API.

The one or more modules 508 also comprises the receiving module 516, which is configured to collect incoming exercise data streams from one or more sensors and conversion units associated with isokinetic exercise devices 102. The receiving module 516 may include drivers, APIs, or middleware designed to interface with analog-to-digital conversion circuits, wireless communication modules (e.g., Bluetooth, Wi-Fi, NFC), or wired connections (e.g., USB, HDMI). The receiving module 516 may apply validation protocols such as cyclic redundancy check (CRC), secure hash verification, or device signature authentication to ensure that the incoming data is not corrupted or tampered with. The receiving module 516 may also filter anomalies, for example, rejecting data points that exceed physiological thresholds (e.g., impossible force or velocity spikes) or that arise from sensor drift. In some embodiments, the receiving module 516 synchronizes multiple data streams (pressure, displacement, velocity, and resistance settings) by applying timestamp alignment or interpolation. The validated data is then normalized into a structured format (e.g., JSON packets or encrypted binary arrays) before being forwarded to the conversion module 518 for computation.

The one or more modules 508 further comprises the conversion module 518, which is configured to calculate power output and perform token conversion. The conversion module 518 extracts force and velocity parameters from the validated digital exercise data. In some embodiments, force is calculated by multiplying hydraulic pressure readings (from the pressure transducer) by the piston area of the actuator, and velocity is derived by processing accelerometer signals that measure displacement over time or the angular velocity of a lever arm. The module may compute both instantaneous power (force×velocity at a given moment) and average power over an exercise session. The conversion module 518 then applies a watt-to-token algorithm. This algorithm may be linear (e.g., one token unit per predefined wattage) or non-linear (e.g., scaled based on intensity zones, resistance parameters, or workout duration). In some embodiments, bonus multipliers may be applied for surpassing milestones, such as breaking a personal record or sustaining high wattage for extended durations.

The conversion module 518 is further configured to interface with the blockchain network 108. This may include formatting transaction payloads that contain user identifiers, wattage data, and token amounts, and transmitting the payloads to blockchain nodes for consensus validation. The module may also maintain a local ledger for temporary offline storage in case of intermittent connectivity, ensuring tokens are reconciled once a connection is restored. In some embodiments, the conversion module 518 also supports integration with external exchanges, allowing tokens to be automatically converted into other cryptocurrencies or fiat values according to the user's preference.

The one or more modules 508 also comprises the NFT generation module 520, which is configured to mint non-fungible tokens (NFTs) associated with exercise milestones, achievements, or energy credits. The NFT generation module 520 may attach metadata to each NFT, such as the user's unique ID, the exercise performed, the exact wattage achieved, the resistance setting, or the date and time of the session. NFTs can serve as digital proof of performance, allowing users to showcase their accomplishments, participate in fan engagement programs, or trade collectible tokens on secondary markets. In some embodiments, the NFT generation module 520 may generate dynamic NFTs whose properties evolve over time as a user completes more workouts (e.g., a digital medal that changes color or level with continued training). NFTs may also be tied to fan marketplaces, granting rewards such as exclusive training sessions, merchandise, or access to athlete-driven communities. The NFT generation module 520 may further interoperate with the conversion module 918, linking tokens and NFTs such that milestone-based NFTs are automatically minted once a user crosses predefined energy or token thresholds.

The one or more modules 508 may further comprise other modules 522, which extend the server's 106 functionalities beyond core operations. For example, an analytics module may compute long-term performance trends, predict recovery timelines, or provide coaches with advanced metrics derived from historical session data. An energy management module may track the amount of electrical energy harvested and stored in batteries during exercise sessions, generate energy credits, and integrate these credits into token conversion or NFT minting. A fraud detection module may apply machine learning algorithms to identify suspicious usage patterns, such as repeated identical data streams or unrealistic performance levels, thereby preventing token farming or system abuse. Additionally, an exchange integration module may provide secure APIs to external cryptocurrency exchanges, enabling seamless token trading, liquidity management, and conversion into other assets.

It will be appreciated that the aforementioned modules may be implemented in software, firmware, hardware, or a combination thereof. Furthermore, depending on system requirements, these modules may be represented as discrete components or integrated into composite modules that run on a shared computing infrastructure.

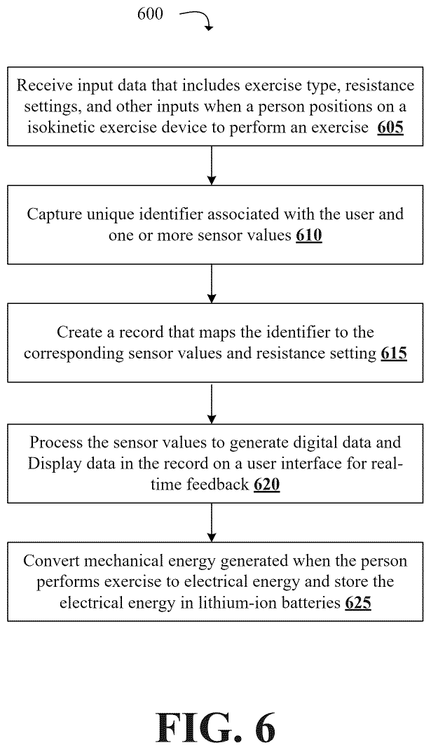

FIG. 6 illustrates a flow diagram 600 of an example method for capturing exercise records in accordance with some embodiments of the present disclosure.

At step 605, the method begins by receiving input data that includes one or more of: an exercise type selected by the user, resistance settings manually or electronically configured on the hydraulic resistance control valve, and other contextual inputs provided through a user interface. The input data may be obtained when a person positions on an isokinetic exercise device to initiate an exercise session. The resistance setting can be selected using the dual adjustment dials of the hydraulic resistance control valve. In some embodiments, dial settings may also be tracked by embedded accelerometer devices to capture precise calibration values. The exercise type may be predefined (e.g., shoulder abduction, elbow flexion, ankle dorsiflexion) and linked to the corresponding exercise attachment mounted on the actuator.

At step 610, the method captures a unique identifier associated with the user, along with one or more sensor values generated during the exercise session. The unique identifier may include a machine-readable code, such as a QR code or NFC tag, scanned from the device, or a biometric identifier (e.g., fingerprint, facial recognition) authenticated through a user device. The one or more sensor values may include hydraulic pressure signals measured by a pressure transducer fluidly coupled to the hydraulic resistance control valve, displacement and angular velocity signals measured by accelerometers positioned on lever arms or exercise attachments, and resistance parameters associated with dial positions. By combining user identity with captured sensor signals, the system ensures that performance data is uniquely attributed to the correct individual.

At step 615, a record is created that maps the user's unique identifier to the corresponding sensor values and resistance setting. The record may include a timestamp, exercise type, and a log of session configuration parameters. The mapping enables the consistent tracking of user progress across multiple sessions and provides a data structure suitable for further processing. The record may be stored locally in the memory of the isokinetic device or transmitted to a remote server or blockchain ledger for persistent storage and validation.

At step 620, the sensor values captured during the exercise session are processed to generate digital exercise data. Processing may include converting raw analog sensor signals into digital values using an analog-to-digital (A/D) conversion module, filtering noise, and performing calculations such as instantaneous force, displacement, velocity, and power output. The processor computes instantaneous power as the product of measured force (derived from hydraulic pressure and piston area) and velocity (derived from displacement over time), yielding power in watts. The generated digital data can be displayed on a user interface in real-time, allowing the user to monitor performance parameters such as the resistance applied, repetitions completed, and wattage output. Real-time visual feedback provides motivational, rehabilitative, and diagnostic value, allowing users and clinicians to track exercise quality and consistency.

At step 625, the method further comprises converting the mechanical energy generated by the user during exercise into electrical energy. In some embodiments, this conversion is achieved by coupling the actuator or hydraulic pump to an electromechanical generator that translates linear or rotary motion into electrical output. The generated electrical energy is directed into a storage subsystem, such as lithium-ion batteries, for later use. The storage of electrical energy allows for offsetting system power consumption, integrating with renewable energy frameworks, or contributing stored energy to external loads. The lithium-ion battery system may also include a weir and baffle arrangement to manage fluid expansion within the hydraulic circuit, as well as charge controllers to ensure stable storage and discharge.

The flow diagram 600 therefore illustrates a comprehensive process whereby exercise activity is digitized, linked to a user identity, and converted into both performance metrics and tangible stored energy. This dual pathway of (a) digital exercise data generation and (b) mechanical-to-electrical energy conversion enables not only accurate tracking and feedback for the user but also energy harvesting for sustainable utilization of power generated during physical exercise.

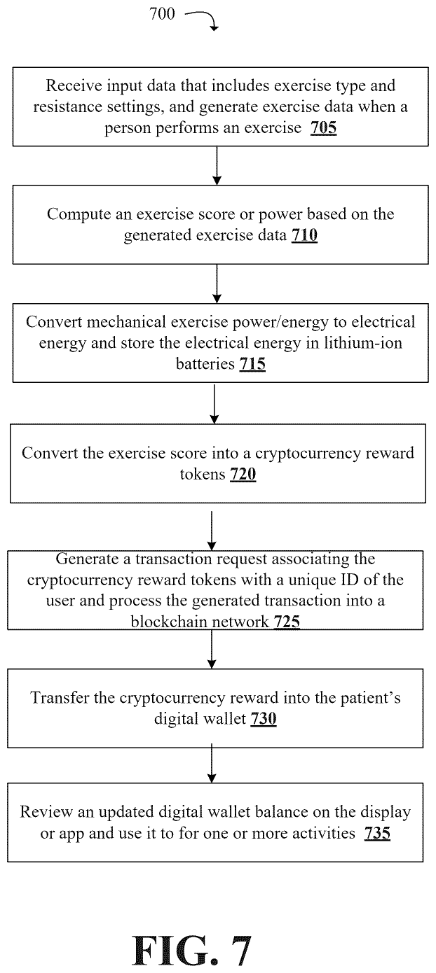

FIG. 7 illustrates a flow diagram 700 of an example method for converting exercise activity into cryptocurrency reward tokens, in accordance with some embodiments of the present disclosure. The process builds upon biomechanical measurement of human effort, electronic data capture, energy harvesting, and blockchain integration to provide a secure, tokenized incentive system.

At step 705, the method begins by receiving input data that includes one or more of: (i) the exercise type being performed by the user, (ii) resistance settings configured on the hydraulic resistance control valve, and (iii) contextual inputs such as session duration, biometric identifiers, or authentication scans. When the person performs an exercise on the isokinetic device, sensors embedded within the device generate exercise data in real-time. For example, a pressure transducer measures hydraulic pressure signals that correspond to the load generated by the actuator, while accelerometers measure displacement, speed, or angular rotation of lever arms or exercise attachments. The input data, therefore, provides both configuration context (exercise type, resistance level) and raw sensor measurements (force- and velocity-related signals).

At step 710, the sensor values are processed to compute an exercise score or power output. In some embodiments, the processor executes an algorithm that determines power in watts according to the formula:

Power (W)=Force (N)×Velocity (m/s).

Force is calculated by multiplying the measured hydraulic pressure (Pascals) by the piston area of the actuator, yielding a value in Newtons. Velocity is computed from the rate of displacement measured by accelerometers mounted on the exercise attachment or lever arm. By combining these two measured values, the system generates both instantaneous and average power data for the user's session. The exercise score may be a direct wattage measurement, a normalized score based on session length, or a scaled value for gamified comparisons across users.

At step 715, the mechanical exercise power is harvested as electrical energy. The actuator 302 is coupled to an electromechanical generator via a rotary pump or manifold, enabling hydraulic fluid motion to be converted into electric current. The generated current is directed through inverters and charge controllers and stored in lithium-ion batteries. In some embodiments, the battery system includes a weir and baffle plate design to manage volumetric expansion, temperature-induced viscosity changes, and removal of entrained air. This ensures long-term stability of the hydraulic fluid system and reliable energy storage. By capturing and storing electricity, the system provides an additional layer of value: exercise effort is transformed into renewable energy that can power auxiliary systems or be fed back into the grid.

At step 720, the computed exercise score (watts) is converted into cryptocurrency reward tokens. A watt-to-token conversion pipeline is implemented, where a fixed or dynamic exchange rate (e.g., 0.00001 ATHX tokens per watt) is applied to the measured power output. In some embodiments, conversion factors may account for device efficiency, calibration offsets, or session length multipliers to ensure fairness across different users and machines. This step ensures that physical output is directly and transparently represented in tokenized digital value.

At step 725, a transaction request is generated to associate the reward tokens with the authenticated user. The user may be identified by a machine-readable tag (QR/NFC) on the exercise device, or by biometric input captured via the user device 104. The transaction request encapsulates the user identifier, the watt-to-token conversion data, and session metadata. The transaction is processed by a blockchain network, which immutably records the issuance of tokens, verifies authenticity through consensus protocols, and prevents tampering or duplication.

At step 730, the reward tokens are transferred into the user's digital wallet. The wallet may be a software wallet on a mobile app, a hardware wallet provided by the manufacturer, or an account on a cloud-based custodial platform. The tokens can be freely traded, exchanged, or redeemed for goods, services, or benefits. This step ensures seamless transfer of earned cryptocurrency value to the end-user.

At step 735, the user can review the updated wallet balance on a connected display, kiosk, or user device application. Real-time updates provide immediate feedback and motivation, showing the user how much cryptocurrency was earned during the session. Beyond motivational use, the tokens can also be applied toward practical activities such as paying subscription fees, participating in gamified leaderboards, purchasing fitness-related services, or trading on third-party exchanges.

The method of FIG. 7 therefore creates a closed-loop ecosystem where (a) biomechanical measurements of exercise performance (force, velocity, and power) are transformed into digital exercise scores, (b) mechanical energy is harvested as electrical energy and stored in batteries, and (c) digital tokens are generated, verified on a blockchain, and transferred into a user's wallet for immediate use. This integration of exercise science, hydraulic control systems, energy harvesting, and blockchain tokenization provides both tangible energy benefits and verifiable digital incentives, making the system highly adaptable for rehabilitation, sports training, and consumer fitness markets.

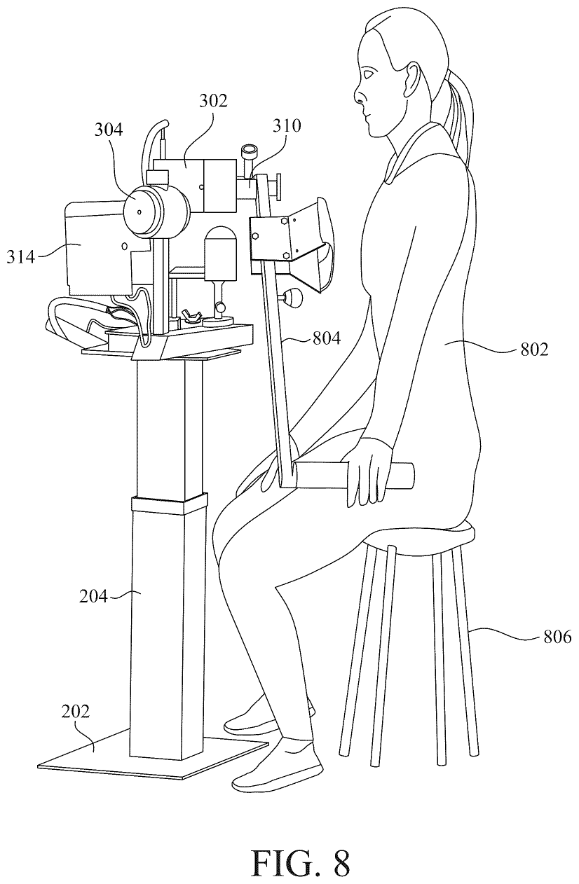

FIG. 8 shows a user 802 performing shoulder abduction using the isokinetic exercise device 102, in accordance with some embodiments of the present disclosure. As illustrated, the isokinetic assembly 206 includes the actuator 302 operably coupled to a torque arm 310, to which a shoulder abduction handle attachment 804 (also known as an exercise attachment). The user 802 is shown seated on a seat 806 positioned adjacent to the isokinetic exercise device 102, and grips the shoulder abduction handle attachment 804 to perform the shoulder abduction exercise.

During operation, the user's movement of the shoulder abduction handle attachment 804 displaces the torque arm 310, which in turn actuates the actuator 302. This motion forces hydraulic fluid through the hydraulic resistance control valve 304, thereby generating a controlled resistance load against which the user exercises. The isokinetic characteristics of the isokinetic exercise device 102 ensure that the speed of movement remains substantially constant, regardless of how much force the user applies, thereby promoting safe and repeatable motion.

In some embodiments, the user 802 may adjust resistance by operating dials located on the hydraulic resistance control valve 304. The dual-dial configuration, which utilizes two dials, may enable independent adjustment of resistance during actuator extension and retraction, allowing for exercise programs that emphasize different muscle groups at various phases of the motion. For example, a therapist may configure higher resistance during the upward phase of shoulder abduction while providing reduced resistance during the downward return phase.

While performing the exercise, the user 802 may also receive real-time performance feedback through the user device 104 or the electronic device 316 communicatively coupled to the electronics control unit 314. Metrics displayed may include torque, range of motion, angular velocity, power output, and accumulated exercise tokens generated via watt-to-token conversion. These performance indicators may be assessed by the user or a supervising therapist to modify exercise parameters, track rehabilitation progress, or optimize training intensity.

Although FIG. 8 illustrates shoulder abduction as an exemplary exercise, it should be understood that the shoulder abduction handle attachment 804 is interchangeable and may be replaced with other attachments to facilitate different movements. For instance, pedal attachments can be used for lower-limb cycling exercises, a platform can be used for leg press movements, or handles can be used for trunk or cervical rotation therapy. In this way, the isokinetic assembly 206 supports a wide range of training and rehabilitation exercises across multiple muscle groups and joints.

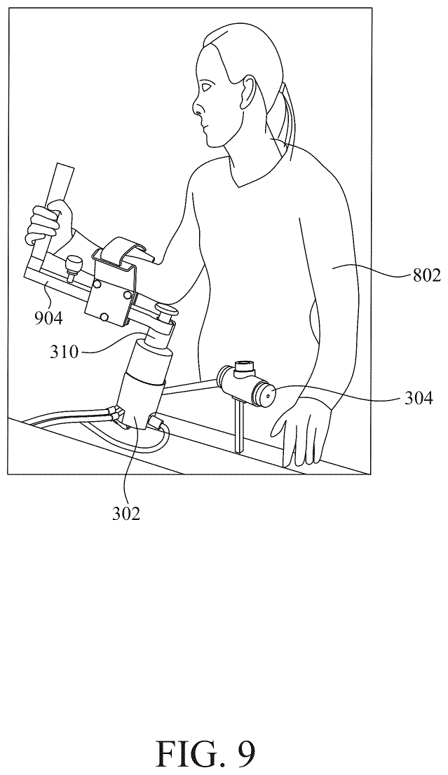

FIG. 9 illustrates a user 802 performing a shoulder internal rotation exercise using a handle-type exercise attachment 904, in accordance with some embodiments of the present disclosure. The handle-type exercise attachment 904 (also known as an exercise attachment) is mechanically coupled to the actuator 302 through the torque arm 310 of the isokinetic assembly 206 and is configured in this example as a handle-type attachment suitable for upper body rotational movements. The user 802 grips the handle-type exercise attachment 904 and rotates it inward across the body to perform the internal rotation movement, while the actuator 302 provides controlled resistance, regulated by the hydraulic resistance control valve 304, as described in earlier figures.

During the shoulder internal rotation exercise, the actuator 302 converts the applied muscular effort into hydraulic pressure, which is stabilized and varied by the resistance control valve. The motion of the handle-type exercise attachment 904 generates displacement and angular velocity data, while the hydraulic system produces corresponding pressure values. These parameters are collected by the electronic control unit 314 to create digital exercise data representative of the user's rotational strength and range of motion.

In some embodiments, the handle-type exercise attachment 904 may be replaced with other interchangeable attachments, such as pedals, lever arms, or rotary members, enabling the system to support a wide range of exercises. The configuration shown in FIG. 9 is particularly suited for rotator cuff strengthening and rehabilitation protocols, where precise resistance and range of motion control are required to progress a recovering patient safely.

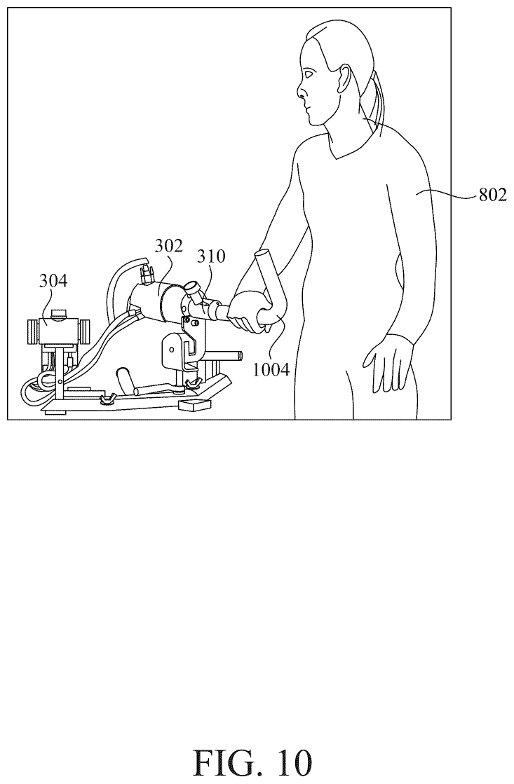

FIG. 10 illustrates a user 802 performing a wrist strengthening exercise using a wrist strengthening attachment 1004, in accordance with some embodiments of the present disclosure. The wrist strengthening attachment 1004 (also known as an exercise attachment) in this example is configured as a contoured handle specifically shaped to be grasped by the user's hand and rotated at the wrist joint. The user 802 grips the handle firmly and executes controlled flexion and extension of the wrist while resistance is applied by the actuator 302 under the regulation of the hydraulic resistance control valve.

During the exercise, the torque applied by the user's wrist is transmitted through the wrist strengthening attachment 1004 and torque arm 310 into the actuator 302, where it is converted into hydraulic pressure. The generated pressure is then modulated by the resistance control valve, enabling precise adjustment of the load experienced by the user. Concurrently, displacement and angular velocity of the wrist motion are detected by sensors associated with the actuator 302 and the torque arm 310. This data, combined with measured hydraulic pressure, forms the exercise dataset, which is then processed to determine the user's power output and training metrics.

The configuration shown in FIG. 10 is particularly suited for wrist rehabilitation and forearm strengthening, where controlled resistance and limited range of motion are essential. Such exercises may be beneficial in recovery from tendon injuries, carpal instability, or for improving grip and forearm strength in athletes.

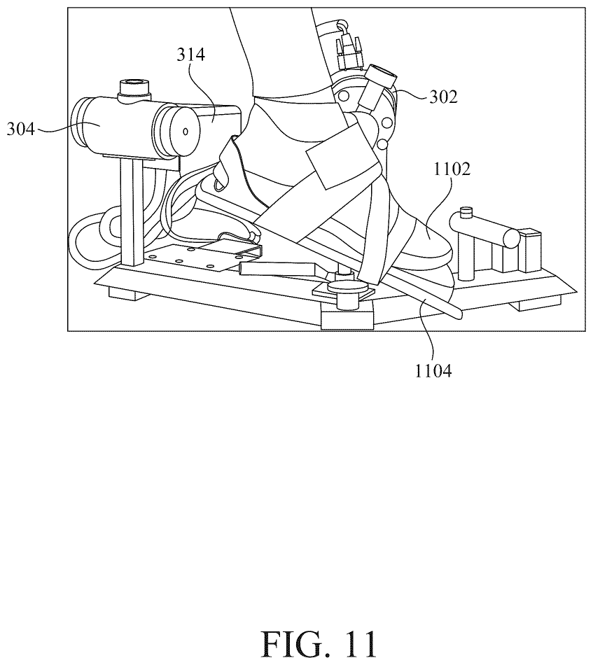

FIG. 11 illustrates a user 802 performing ankle flexion and extension movements using an ankle exercise attachment 1104, in accordance with some embodiments of the present disclosure. The ankle exercise attachment 1104 (also known as an exercise attachment) is configured to receive the foot 1102 and lower leg of the user 802 and may include a cushioned platform, straps, or harnesses to hold the ankle securely in place during exercise and prevent the ankle movement relative to the machine itself or the platform where the ankle rests. In this example, the ankle exercise attachment 1104 is designed for performing ankle flexion and extension movements, such as dorsiflexion and plantarflexion, under controlled resistance generated by the actuator 302.

When the user 802 moves the ankle against the attachment 1104, torque is transmitted through the actuator 302 into the hydraulic resistance control valve, which regulates fluid flow to establish the resistance load. The actuator 302 thereby provides controlled opposition to the user's ankle movement, allowing both strength training and rehabilitative exercises to be carried out in a safe and repeatable manner. Sensor devices associated with the actuator 302 capture parameters such as angular displacement, speed of motion, and the corresponding hydraulic pressure, enabling the generation of digital exercise data representative of the user's ankle performance.

The configuration depicted in FIG. 11 is particularly suited for rehabilitation of ankle injuries such as ligament sprains, Achilles tendon recovery, or post-surgical rehabilitation where controlled range of motion and progressive resistance are required. In athletic training contexts, attachment 1104 may also be used to improve balance, stability, and lower limb explosive strength. In some embodiments, the ankle exercise attachment 1104 may be removable and interchangeable with other attachments, allowing a single system to accommodate exercises targeting different joints or muscle groups.

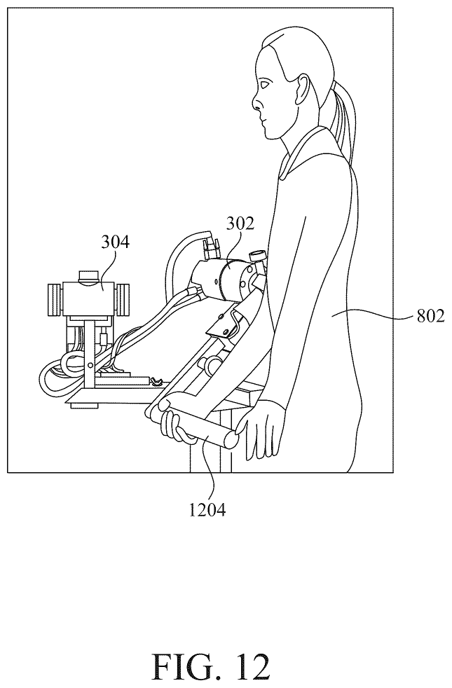

FIG. 12 illustrates a user 802 performing elbow flexion and extension exercise using an elbow exercise attachment 1204, in accordance with some embodiments of the present disclosure. The elbow exercise attachment 1204 (also known as an exercise attachment) is gripped by the user 802 and moved through the range of motion of the elbow joint. The actuator 302 provides resistance to the elbow movement by transferring user-applied force into hydraulic pressure, which is regulated by the hydraulic resistance control valve to create a variable load.

As the user flexes and extends the elbow, the elbow exercise attachment 1204 and actuator 302 produce measurable displacement and angular velocity, while corresponding hydraulic pressure data is generated in response to the applied effort. These parameters are captured by the electronic control unit 314 and processed into digital exercise data representative of the user's elbow strength, endurance, and movement control.

The configuration shown in FIG. 12 is particularly applicable to the rehabilitation of elbow injuries, such as ligament sprains, post-surgical recovery, or tendon repair, where controlled resistance and precise monitoring of the range of motion are required. In athletic applications, the elbow attachment 1204 may also be used for strengthening upper-arm muscles, including the biceps and triceps, under repeatable and measurable resistance conditions.

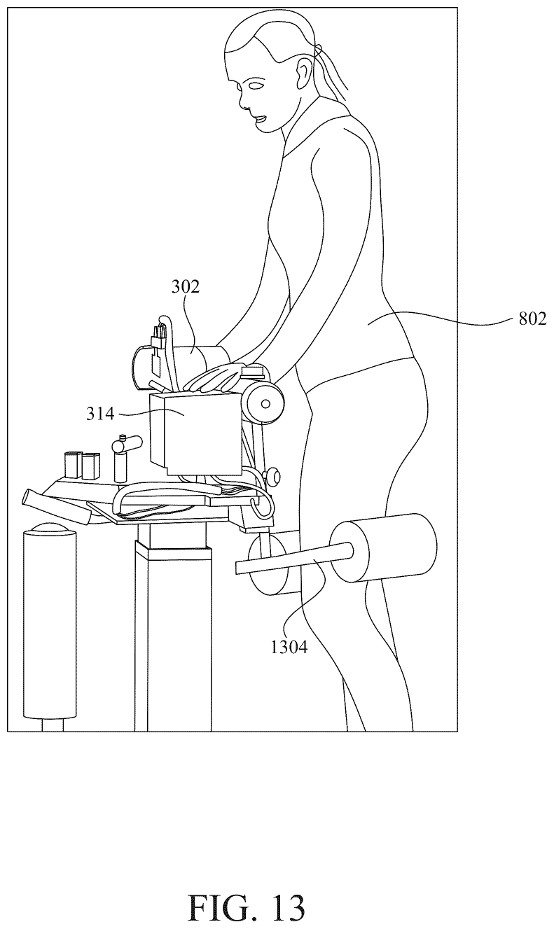

FIG. 13 illustrates a user 802 performing hip flexion, extension, abduction, and adduction exercises using a hip exercise attachment 1304, in accordance with some embodiments of the present disclosure. The hip exercise attachment 1304 (also known as an exercise attachment) comprises a padded cylindrical roller mounted on a lever arm, which is mechanically coupled to the actuator of the isokinetic assembly. The user positions the thigh or lower leg against the padded surface, and upon initiating movement, applies muscular effort through the hip joint to move the hip exercise attachment 1304.

During the exercise, the hip exercise attachment 1304 transmits the user's applied force through the lever arm into the actuator, which converts the mechanical input into hydraulic pressure. The hydraulic resistance control valve 304 then regulates fluid flow to generate a controlled and repeatable resistance load. Sensor devices associated with the actuator and attachment measure displacement, angular velocity, and corresponding hydraulic pressure, thereby producing digital exercise data that reflects the user's hip strength and mobility.

The configuration shown in FIG. 13 is particularly suited for exercises that involve hip flexion, extension, abduction, and adduction, which may be critical in rehabilitation following hip replacement surgery, muscle strain recovery, or the treatment of hip instability. In athletic contexts, the hip exercise attachment 1304 may be used for developing lower-body power, stability, and functional movement patterns relevant to sports performance.

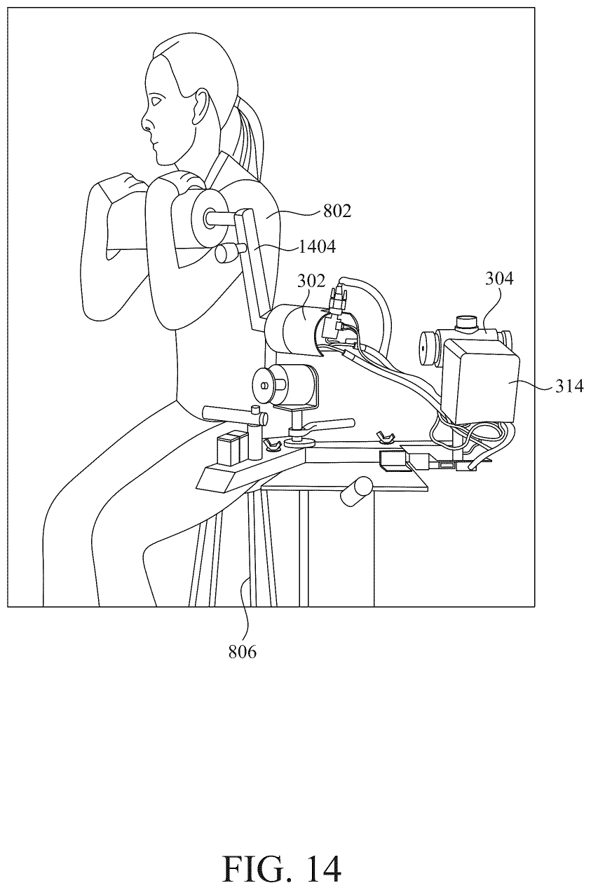

FIG. 14 illustrates a user 802 performing an exercise with a trunk exercise attachment 1404, in accordance with some embodiments of the present disclosure. The trunk exercise attachment 1404 in the illustrated embodiment is structurally similar to the hip exercise attachment 1304, comprising a padded cylindrical roller mounted on a lever arm and mechanically coupled to the actuator of the isokinetic assembly. In this configuration, however, the padded roller is positioned against the user's upper torso or chest so that trunk flexion, extension, or rotational exercises may be performed.

When the user 802 applies force against the trunk exercise attachment 1404, the lever arm transmits the applied effort into the actuator, which converts the mechanical input into hydraulic pressure. The hydraulic resistance control valve regulates the flow of hydraulic fluid, thereby producing a controlled resistance load that opposes the trunk movement. During the exercise, displacement, angular velocity, and hydraulic pressure are monitored by sensors associated with the actuator and conversion unit, generating digital exercise data indicative of the user's trunk strength, stability, and range of motion.

The configuration shown in FIG. 14 is particularly applicable for core strengthening and trunk rehabilitation exercises, including recovery from spinal injuries, postural corrections, and stability training. In sports and fitness contexts, the trunk exercise attachment 1404 may be used to enhance core endurance, rotational power, and functional movement control.

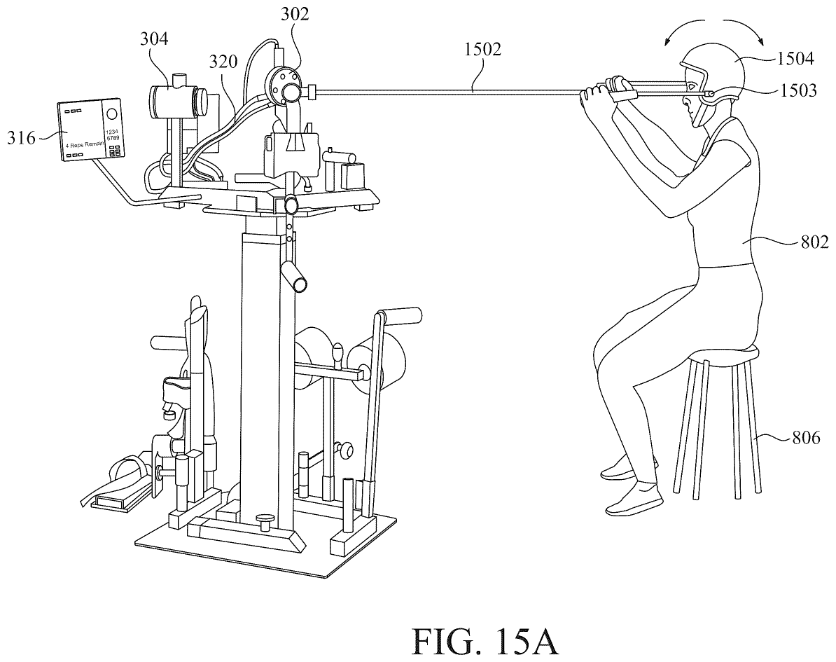

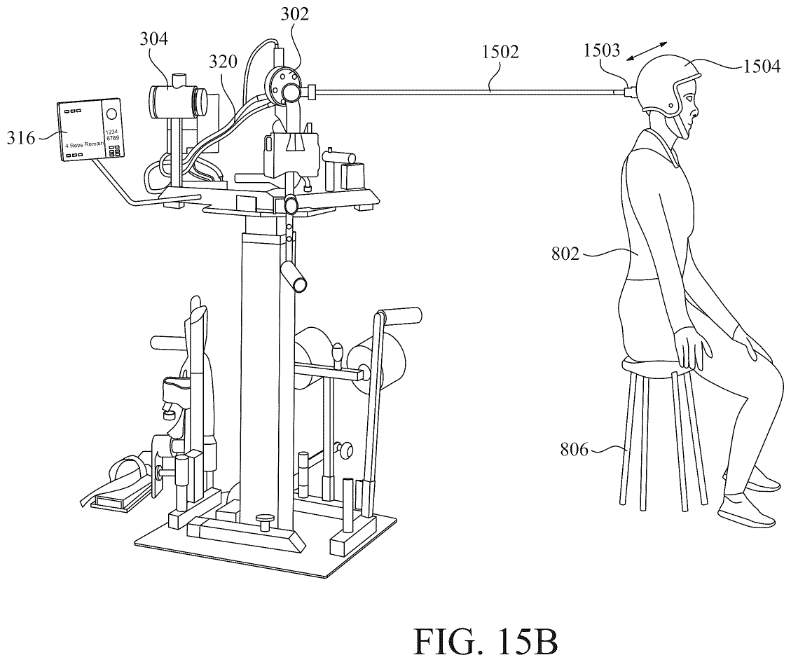

FIG. 15A illustrates a user 802 performing a cervical flexion and extension exercise using a helmet attachment or a head harness 1504, which is connected to a rotary axis of the isokinetic exercise device, in accordance with some embodiments of the present disclosure. The helmet attachment 1504 is securely fastened to the user's head (alone or in combination with additional securing means, such as straps (not shown)) and coupled via a rotary linkage 1502 to the actuator 302. In the illustrated configuration, the user 802 is seated on the stool 806 facing the machine and performs forward-and-backward head movements (flexion and extension) against controlled resistance applied through the helmet attachment 1504. The linkage 1502 may be connected to a pair of drive attachments 1503 located on the sides of the helmet attachment 1504 to allow forward-and-backward head movements while performing exercise.

During operation, force exerted by the user's cervical and upper spinal muscles is transmitted through the helmet linkage to the actuator 302, which converts the mechanical motion into hydraulic pressure. The hydraulic resistance control valve 304 regulates this pressure to provide a smooth, adjustable load opposing the user's flexion and extension motion. Sensors associated with the actuator 302 and valve 304 capture displacement, angular velocity, and hydraulic pressure data in real time.

FIG. 15B illustrates a user 802 performing a lateral side-to-side head exercise using the helmet attachment or a head harness 1504 in accordance with some embodiments of the present disclosure. The helmet attachment 1504 is securely worn by the user (alone or in combination with additional securing means, such as straps (not shown)) and coupled via the rotary linkage 1502 to the actuator 302. In the illustrated configuration, the user 802 is seated on the stool 806 facing away and moves the head left side and right side in controlled arcs about the vertical axis of the cervical spine, while resistance is applied through the helmet attachment 1504. The linkage 1502 may be connected to a drive attachment 1503 located on the back of the helmet attachment 1504 to allow lateral head movements while performing exercise. Although FIG. 15B shows the user 802 in a seated position facing away from the machine, it is possible that the user 802 could be seated facing the machine while performing exercise with suitable design changes pertaining to the location of the drive attachment 1503.

During operation, rotational force generated by the user's cervical and upper spinal muscles is transmitted through the helmet linkage to the actuator 302, which converts the rotational motion into hydraulic pressure. The hydraulic resistance control valve 304 modulates the pressure to apply a stable and controllable opposing load throughout the rotational range of motion.

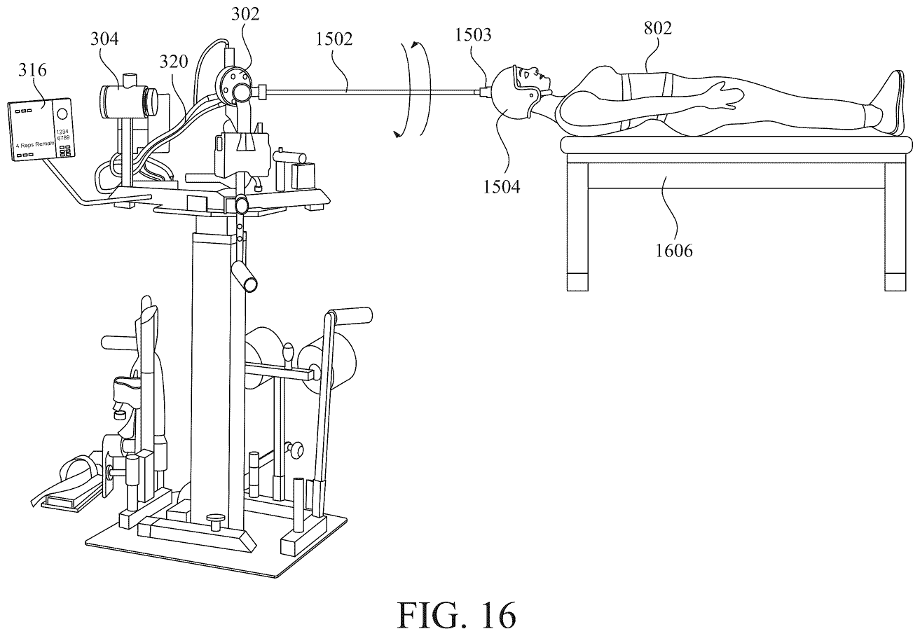

FIG. 16 illustrates a user 802 performing a cervical rotational exercise using the helmet attachment or a head harness 1504 in accordance with some embodiments of the present disclosure. The helmet attachment 1504 is securely worn by the user (alone or in combination with additional securing means, such as straps (not shown)) and connected through the rotary linkage 1502 to the actuator 302. In the illustrated configuration, the user 802 is positioned in a supine posture on a bench 1608 and performs controlled head rotation to the left and right about the longitudinal axis of the cervical spine, while resistance is applied through the helmet interface. Although FIG. 16 shows the user 802 lying on his back on the bench 1608, linkage 1502 is connected to a drive attachment 1503 located on top of the helmet attachment 1504.

During the exercise, torque generated by the user's cervical rotator muscles is transmitted through the helmet attachment 1504 to the actuator 302, which converts the rotational mechanical motion into hydraulic pressure. The hydraulic resistance control valve 304 regulates this pressure to provide a smooth, stable, and adjustable counteracting load throughout the rotational movement.

In FIGS. 15A,15B and 16 the positions of the drive attachment 1503 is merely exemplary, and it may be possible that the drive attachment 1503 may be located at any other suitable locations on the helmet attachment 1504, ensuring the user 802 is able to perform flexion and extension head movement, lateral head movement exercise, prone rotation of head as described above. Also, although the drawings illustrate the head attachment 1504 directly attached to the user's head, it should be understood that other means for securely attaching the helmet or head harness 1504 may be configured together with the head harness to ensure the user's head does not move relative to the helmet or harness itself.

The above description of the shown example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

The foregoing description sets forth various embodiments of a system for generating cryptocurrency coins based on physical exercise. The system integrates hydraulic resistance hardware, interchangeable exercise attachments, electronic control units, processors, and blockchain-based infrastructures to measure user effort, compute power output, and convert the output into tokens and cryptocurrency coins.

At its core, the system includes a hydraulic resistance control valve configured to regulate bidirectional oil flow between an actuator and a reservoir. The hydraulic resistance control valve generates a variable resistance load corresponding to user effort applied through the actuator. In some embodiments, the valve comprises a pair of adjustable dials, each coupled to a load control spring and spool. A check valve arrangement is configured to open in response to spool displacement against the spring preload, thereby allowing controlled fluid flow. A fluid reservoir with a weir and baffle plate unit accommodates volumetric expansion of hydraulic fluid and facilitates the removal of entrained air. This construction ensures stable operation across different fluid conditions. In some implementations, the valve provides a dual unidirectional flow path, with a first dial regulating resistance during actuator extension and a second dial regulating resistance during actuator retraction.

The system further includes an actuator mechanically coupled to one or more exercise attachments operable by a user to perform exercise movements. The exercise attachment may include, without limitation, a lever arm, pedal, handle, platform, or rotary member. In some embodiments, the attachment is mechanically linked to the actuator via a direct piston connection, a pivot linkage mechanism (such as a crank, connecting rod, or pin joint), a rotary crank assembly, or a cable and pulley system. In some embodiments, a first exercise attachment is removable and interchangeable with a second attachment, thereby enabling different exercise types such as leg press, cycling, rowing, or shoulder abduction.

An electronic control unit is configured to capture user effort and motion data, generating digital exercise data. The control unit comprises a pressure transducer fluidly coupled to the valve body of the hydraulic resistance control valve, the pressure transducer being configured to measure hydraulic pressure corresponding to user effort and output a pressure data stream. The control unit further comprises at least one first accelerometer mounted on a dial of the hydraulic resistance control valve to detect resistance load settings, and at least one second accelerometer mounted on a lever arm of the exercise attachment to detect displacement, velocity, or speed of lever arm movement. The control unit aggregates pressure data, motion data, and resistance parameters into a comprehensive exercise data set (exercise data).

A processor communicatively coupled to the electronic control unit is configured to process the exercise data. In some embodiments, the processor calculates a power output in watts based on the pressure data and motion data. The resistance parameter may be recorded as contextual information for validation and used to scale the watt-to-token conversion algorithm, ensuring that token awards are properly adjusted based on resistance settings associated with the calculated power output.

The processor further executes a watt-to-token conversion algorithm to generate exercise tokens. These tokens are transmitted to a blockchain exchange interface, which, in some embodiments, comprises a smart contract configured to validate the authenticity of exercise tokens prior to converting them into cryptocurrency coins. The processor then initiates the conversion of tokens into cryptocurrency coins tradable on a blockchain network. A cryptocurrency wallet associated with the user is configured to receive the coins and update the user's balance.

In some embodiments, the system includes a machine-readable tag such as a QR code or NFC identifier located on one or more of the hydraulic resistance control valve, actuator, exercise attachment, electronic control unit, or processor. The tag may be scanned by a user device application to initiate user authentication prior to an exercise session, and to securely bind exercise performance to an authenticated user account. Upon completion of the session, scanning enables the processor to transmit exercise tokens to the blockchain interface and direct converted cryptocurrency coins into the user's wallet.

The processor may also be configured to mint non-fungible tokens (NFTs) or fan tokens associated with specific events, such as completion of an exercise milestone, achieving a high-output session, or attaining a leaderboard ranking. These tokens may represent digital performance milestones, fan engagement badges, or tradable digital collectibles, and may be deposited into the user's cryptocurrency wallet. Such NFTs or fan tokens may be further configured to be purchased, traded, or transferred on blockchain-based marketplaces, enabling fan engagement and value exchange linked to user achievements.

In another embodiment, the system comprises an energy storage device configured to store electrical energy generated from user exercise. The energy may be harvested through electromechanical conversion of actuator motion and stored in one or more lithium-ion batteries. Stored energy may serve as a power source for the system or may be tokenized into energy credits.

The system may further include an analytics dashboard configured to display performance metrics derived from the exercise data. The dashboard may present session statistics, cumulative performance, or token earnings, and may include a global leaderboard ranking users based on accumulated power output, exercise tokens earned, or NFTs obtained.

Through the combination of hydraulic resistance control hardware, electronic sensing, digital processing, blockchain integration, energy storage, and analytics, the disclosed system enables accurate measurement of exercise effort, fair tokenization of physical output, generation of digital rewards, and secure engagement through blockchain networks.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for generating cryptocurrency coins based on physical exercise, comprising:
a hydraulic resistance control valve configured to regulate bidirectional oil flow between an actuator and a reservoir, the hydraulic resistance control valve generating a variable resistance load in response to user effort;
an actuator coupled to the hydraulic resistance control valve;
an exercise attachment mechanically coupled to the actuator, the exercise attachment operable by a user to perform an exercise;
an electronic control unit configured to capture user effort and motion data and generate digital exercise data;
a processor communicatively coupled to the electronic control unit, the processor configured to:
calculate a power output in watts based on the digital exercise data;
convert the power output into exercise tokens according to a watt-to-token conversion algorithm;
transmit the exercise tokens to a blockchain exchange interface; and
initiate conversion of the exercise tokens into cryptocurrency coins tradable on a blockchain network; and
a cryptocurrency wallet associated with the user and configured to receive the cryptocurrency coins.

2. The system of claim 1, wherein the hydraulic resistance control valve comprises:
a pair of adjustable dials, each coupled to a load control spring and a spool;
a check valve arrangement configured to open in response to displacement of the spool against the load control spring; and
a fluid reservoir with a weir and baffle plate unit configured to accommodate volumetric expansion of hydraulic fluid and to remove entrained air,
wherein an operation of each of the pair of adjustable dials adjusts the preload on the load control springs to vary a port opening of the check valves, to regulate bidirectional oil flow through the actuator, and establish variable resistance corresponding to user effort.

3. The system of claim 2, wherein the hydraulic resistance control valve is configured to provide a dual unidirectional flow path, wherein one flow path through a first dial regulates resistance during actuator extension and the other flow path through a second dial regulates resistance during actuator retraction.

4. The system of claim 1, wherein the electronic control unit comprises:
a pressure transducer fluidly coupled to a valve body of the hydraulic resistance control valve, the pressure transducer configured to measure a hydraulic pressure corresponding to a user effort applied through the actuator, and output a pressure data stream representative of the user effort.

5. The system of claim 4, wherein the electronic control unit further comprises:
at least one first accelerometer sensor mounted on a dial of the hydraulic resistance control valve, the first accelerometer sensor configured to detect a dial setting corresponding to a resistance load selection and to output a resistance parameter indicative of the dial position; and
at least one second accelerometer sensor mounted on a lever arm of the exercise attachment, the second accelerometer sensor configured to detect displacement, velocity, or speed of the lever arm during exercise, and to output motion data indicative of lever arm movement.

6. The system of claim 5, wherein the electronic control unit is configured to generate exercise data comprising pressure data from the pressure transducer, motion data from the accelerometer sensor mounted on the exercise attachment, and a resistance parameter from the accelerometer sensor mounted on a dial of the hydraulic resistance control valve, and
wherein the processor is configured to:
calculate a power output in watts based on the pressure data and the motion data; and
utilize the resistance parameter as contextual information for validation and scaling of a watt-to-token conversion algorithm, such that token awards are adjusted based on the resistance setting associated with the calculated power output.

7. The system of claim 1, wherein the exercise attachment comprises at least one of a lever arm, pedal, handle, platform, or rotary member operable by a user to perform exercise.

8. The system of claim 7, wherein the exercise attachment is mechanically coupled to the actuator through at least one of: a direct piston connection, a pivot linkage mechanism, a rotary crank assembly, and a cable and pulley system, wherein the pivot linkage mechanism comprises at least one of a crank, a connecting rod, and a pin joint.

9. The system of claim 1, wherein the exercise attachment is a first exercise attachment that is removable and interchangeable with a second exercise attachment, wherein the first exercise attachment comprises a lever arm, and wherein the second exercise attachment comprises at least one of a pedal, handle, platform, or rotary member.

10. The system of claim 1, wherein at least one of the hydraulic resistance control valve, the actuator, the exercise attachment, the electronic control unit, or the processor includes a machine-readable tag comprising a QR code or NFC identifier, the machine-readable tag being scannable by a mobile application on a user device,
wherein scanning the machine-readable tag:
initiates user authentication with the system prior to commencement of an exercise session; and
enables the processor, upon completion of the exercise session, to transmit exercise tokens converted from the calculated power output to the blockchain exchange interface for conversion into cryptocurrency coins, and to direct transfer of the cryptocurrency coins into the cryptocurrency wallet associated with the user.

11. The system of claim 1, wherein the blockchain exchange interface comprises a smart contract configured to validate an authenticity of the exercise tokens prior to conversion into the cryptocurrency coins.

12. The system of claim 1, wherein the processor is further configured to generate a non-fungible token (NFT) associated with completion of an exercise milestone, the NFT being transferable to the cryptocurrency wallet of the user.

13. The system of claim 1, further comprising an energy storage device configured to store an electrical energy generated from the power output and store the electrical energy in at least one lithium-ion battery.

14. The system of claim 1, wherein the processor is further configured to mint a non-fungible token (NFT) or fan token based on completion of a high-output exercise session, the NFT or fan token being transferable to the cryptocurrency wallet of the user.

15. The system of claim 1, further comprising an analytics dashboard configured to display performance metrics derived from the exercise data, the analytics dashboard including a global leaderboard ranking users based on accumulated power output, exercise tokens earned, or NFTs obtained.

16. The system of claim 14, wherein the fan token or NFT is configured to represent at least one of: a performance milestone, leaderboard ranking, or fan engagement badge, and is tradable on a blockchain network.

17. The system of claim 14, wherein the fan token or NFT minted from a high-output exercise session is further configured to be purchased, traded, or transferred by fans through a blockchain-based marketplace, such that fan engagement is enabled by associating the fan token or NFT with performance achievements of the user.
